(19) United States
(12) Patent Application Publication
(10) Pub. No.: US 2009/0245832 A1
(43) Pub. Date: Oct. 1, 2009

(54) DEVELOPMENT CARTRIDGE, DEVELOPMENT UNIT, AND IMAGE FORMING APPARATUS

(75) Inventors: Takeshi Aoki, Matsumoto-shi (JP); Katsumi Okamoto, Azumino-shi (JP); Koji Migita, Matsumoto-shi (JP); Makoto Sato, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/411,564

(22) Filed: Mar. 26, 2009

(30) Foreign Application Priority Data
Mar. 31, 2008 (JP) 2008-089100

(51) Int. Cl. G03G 15/08

(52) U.S. Cl. 399/53

(57) ABSTRACT

A development cartridge includes: a developer carrier which carries toner; a toner supply member which supplies the toner to the developer carrier; a regulation member which regulates an amount of toner on the developer carrier; a development chamber which has the developer carrier and the toner supply member; a transport section which is connected to an upper portion and a lower portion of the development chamber to transport the toner from the lower portion of the development chamber to the upper portion of the development chamber; a transport member which is disposed inside the transport section and transports the toner while agitating the toner; an input member which inputs a print image; and a control member which controls a toner transport speed of the transport member in accordance with the print image.

### BACKGROUND

1. Technical Field

The present invention relates to a development cartridge developing an electrostatic latent image on a latent image carrier by developer, a development unit, and an image forming apparatus.

2. Related Art

There is known an electrographic recording type image forming apparatus exposing and forming an electrostatic latent image on the surface of a latent image carrier on the basis of image data. This image forming apparatus forms an image by allowing a development unit to develop the electrostatic latent image using toner and transferring a toner image formed on the surface of the latent image carrier onto a record medium such as a record sheet. Recently, the electrographic recording type image forming apparatus has been generally designed so as to detachably mount a toner cartridge incorporated with or separated from a development unit and storing toner. In addition, when the stored toner is consumed by repeatedly developing the electrostatic latent image on the surface of the latent image carrier, the toner cartridge is exchanged to supplement toner for developing the electrostatic latent image on the surface of the latent image carrier.

In the development unit, since the toner in the development chamber is agitated for a long time by an agitating member, a toner supply roller, and a regulation blade, a charging capability deteriorates. When the toner cartridge is exchanged and new toner and the deteriorated toner remaining in the development chamber are agitated and mixed for use, the new toner with a high charging capability is selectively charged and the deteriorated toner is insufficiently charged. Therefore, since a total charge amount of the agitated and mixed toner becomes insufficient, control leakage or blushing to a non-image portion may occur due to the insufficient total charge amount of the agitated and mixed toner. In order to prevent the control leakage or the blushing, JP-A-2000-181216 discloses a technique for processing the deteriorated toner remaining in the development chamber in such a manner that driving time of a development unit is counted to perform forcible writing in the non-image portion in accordance with the driving time and toner deteriorated in the charging capability in the development chamber is consumed.

However, this known technique has a problem in that the toner different in a deterioration state (charging property) in the development chamber coexist and the control leakage or the blushing may occur due to mixture of the toner different in the charge amount. Moreover, when a print image is changed, a charge amount matching with the print image could not be obtained.

### SUMMARY

An advantage of some aspects of the invention is that it provides a development cartridge capable of changing a charge amount of toner in a development chamber to match with a print image, when the print image is changed, a development unit, and an image forming apparatus.

According to an aspect of the invention, there is provided a development cartridge including: a developer carrier which carries toner; a toner supply member which supplies the toner to the developer carrier; a regulation member which regulates an amount of toner on the developer carrier; a development chamber which has the developer carrier and the toner supply member; a transport section which is connected to an upper portion and a lower portion of the development chamber to transport the toner from the lower portion of the development chamber to the upper portion of the development chamber; a transport member which is disposed inside the transport section and transports the toner while agitating the toner; an input member which inputs a print image; and a control member which controls a toner transport speed of the transport member in accordance with the print image. With such a configuration, when the print image is changed, the charge amount of toner in the development chamber can be changed to match with the print image.

The control member may increase the toner transport speed of the transport member, when the print image input by the input member is a high duty image in which a ratio of a toner attachment area occupying the entire image is larger than a predetermined value. Accordingly, in the case of the high duty image, it is possible to reduce the edge effect in which the periphery of the image becomes thick.

The control member may set a plurality of modes, independently sets an appropriate range of a charge amount of toner corresponding to the print image in each of the modes, and adjusts the toner transport speed on the basis of each appropriate range. Accordingly, the user selection range can be broader.

The transport member may include: a lower transport member which is disposed in the lower portion of the development chamber and collects the toner; an upward transport member which transports the toner from a lower side of the development chamber to an upper side of the development chamber; and an upper transport member which is disposed in the upper portion of the development chamber and transports toner to a development chamber entrance. With such a configuration, since time in which the toner in the transport section is agitated becomes longer, the charge amount of toner in the development chamber can be made almost sufficient and uniform.

The upper transport member may include a plurality of transport members which are arranged in parallel and transport the toner alternately in directions reverse to each other. With such a configuration, since time in which the toner in the transport section is agitated becomes longer, the charge amount of toner in the development chamber can be made almost sufficient and uniform.

The regulation member may be disposed below the developer carrier. With such a configuration, it is easier for the toner passing through a nip portion of a development roller a toner supply roller to drop to a lower transport passage.

According to another aspect of the invention, there is provided a development unit including: the development cartridge having the above-described configuration; and a toner cartridge which supplies toner. With such a configuration, when new toner is supplemented from the toner cartridge, the toner is agitated in many portions in the transport section. Accordingly, the charge amount of toner in the development chamber can be made almost sufficient and uniform.

According to still another aspect of the invention, there is provided an image forming apparatus including: a latent image carrier on which an electrostatic latent image is formed; a development unit which develops the electrostatic latent image by developer to form a toner image on the latent image carrier; a transfer unit which transfers the toner image formed on the latent image carrier onto a transfer medium; and a fixing unit which fixes the toner image transferred on the transfer unit. As the development unit, the development unit having the above-described configuration is mounted. Accordingly, a high quality image can be formed with an almost uniform charge amount of toner.

### BRIEF DESCRIPTION OF THE DRAWINGS

The invention will be described with reference to the accompanying drawings, wherein like numbers reference like elements.

FIG. 1 is a diagram illustrating an image forming apparatus according to embodiments.

FIG. 2 is a sectional view illustrating the periphery of a photosensitive member and major constituent elements of a development cartridge.

FIG. 3 is a perspective view illustrating the development cartridge according to a first embodiment of the invention.

FIG. 4 is a sectional view illustrating the development cartridge of FIG. 3 viewed in a direction perpendicular to an axial direction.

FIG. 5 is a top view illustrating a development cartridge according to a second embodiment of the invention.

FIG. 6 is a sectional view illustrating the development cartridge of FIG. 5 viewed in a direction perpendicular to an axial direction.

FIG. 7 is a graph illustrating a relation between a toner transport speed and a charge amount of toner.

FIG. 8 is a flowchart illustrating control of the toner transport speed.

FIG. 9 is a graph illustrating an amount of toner with respect to a charge amount of toner in a lower transport passage.

FIG. 10 is a graph illustrating an amount of toner with respect to a charge amount of toner in a portion through which toner enters the development chamber from the upper transport passage.

### DESCRIPTION OF EXEMPLARY EMBODIMENTS

Hereinafter, exemplary embodiments of the invention will be described with reference to the drawings.

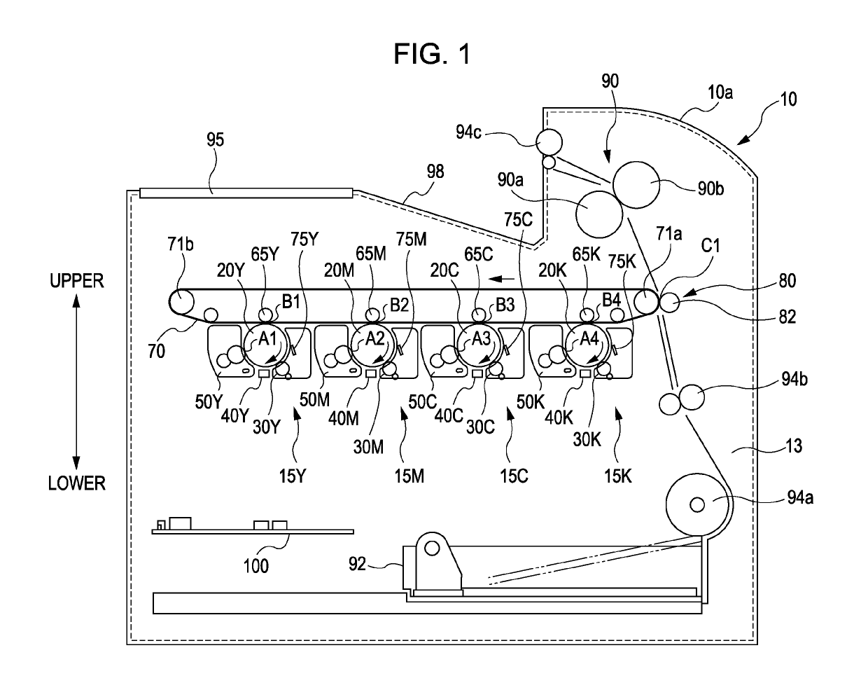

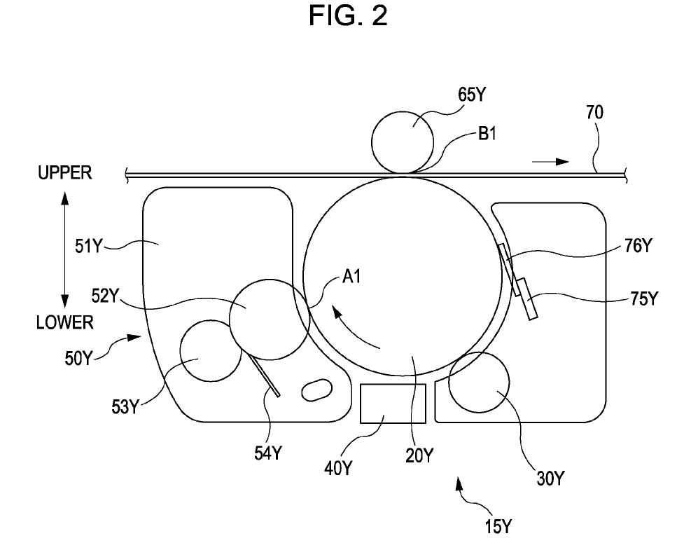

FIG. 1 is a diagram illustrating an image forming apparatus including a development unit according to the embodiments of the invention. FIG. 2 is an enlarged diagram illustrating a yellow image forming station in FIG. 1.

As shown in FIG. 1, an image forming apparatus 10 includes four image forming stations 15 (Y, M, C, and K), an intermediate transfer belt 70, a secondary transfer unit 80, a fixing unit 90, a display unit 95 formed by a liquid crystal panel including a notification unit for notifying messages to a user, and a control unit 100 controlling these units to perform operations of the image forming apparatus.

The image forming stations 15 (Y, M, C, and K) have a function of forming an image using yellow (Y) toner, magenta (M) toner, cyan (C) toner, and black (K) toner, respectively. Since the image forming stations 15 (Y, M, C, and K) have the same configuration, only the configuration of the image forming station 15Y will be described.

As shown in FIG. 2, the image forming station 15Y includes a charging unit 30Y, an exposure unit 40Y, a development cartridge 50Y as a development unit, a primary transfer section B1, a photosensitive member cleaning unit 75Y in a rotation direction of a photosensitive member 20Y as an example of an image carrier.

The photosensitive member 20Y includes a cylindrical body and a photosensitive layer formed on the outer circumferential surface of the cylindrical body and rotates about a central axis. In this embodiment, the photosensitive member 20Y rotates clockwise, as indicated by an arrow.

The charging unit 30Y is a unit which electrically charges the photosensitive member 20Y. A latent image is formed on the charged photosensitive member 20Y by radiating a laser from the exposure unit 40Y.

The exposure unit 40Y includes a semiconductor laser unit, a polygon mirror, and an F-θ lens. The exposure unit 40Y radiates a modulated laser onto the charged photosensitive member 20Y on the basis of an image signal input from a host computer (not shown) such as a personal computer or a word processor.

The photosensitive cartridge 50Y is a unit which develops the latent image formed on the photosensitive member 20Y by using the yellow (Y) toner. The development cartridge 50Y includes a development roller 52Y as a developer carrier and a toner supply roller 53Y as a toner supply member, which are disposed inside a development chamber 51Y to which new toner is supplied from an exchangeable toner cartridge (not shown). A regulation blade 54Y as a regulation member comes in contact with the development roller 52Y to thin the toner on the development roller 52Y.

The primary transfer section B1 is a unit which transfers a yellow toner image formed on the photosensitive member 20Y to an intermediate transfer belt 70. When four color toners are sequentially overlapped and transferred to the primary transfer units B1, B2, B3, and B4, a full-color toner image is formed on the intermediate transfer belt 70.

The intermediate transfer belt 70 is an endless belt which is suspended on a belt driving roller 71a and a driven roller 71b. The intermediate transfer belt 70 is rotatably driven while coming in contact with the photosensitive members 20 (Y, M, C, and K).

The secondary transfer unit 80 is a unit which transfers a mono-color toner image or the full-color toner image formed on the intermediate transfer belt 70 onto a transfer medium such a sheet, a film, or a cloth.

The fixing unit 90 includes a fixing roller 90a and a pressuring roller 90b and forms a permanent image by melting and fixing the mono-color toner image or the full-color image transferred on the transfer medium on the transfer medium.

The photosensitive member cleaning unit 75Y includes a photosensitive member cleaning blade 76Y made of rubber and coming in contact with the surface of the photosensitive member 20Y. The photosensitive member cleaning unit 75Y is a unit which scrapes and removing the toner remaining on the photosensitive member 20Y by use of the photosensitive cleaning blade 76Y after the toner image is transferred onto the intermediate transfer belt 70 by the primary transfer section B1.

Next, operations of the image forming apparatus 10 having the above configuration will be described.

First, when an image signal and a control signal are input from the host computer (not shown) to a main controller of the image forming apparatus through an interface, the photosensitive member 20Y, the development roller 52Y included in the development cartridge 50Y, the toner supply roller 53Y, the intermediate transfer belt 70, and the like are rotated by control of a unit controller in accordance with an instruction supplied from the main controller. The photosensitive member 20Y is charged sequentially at a charging location by the charging unit 30Y, while the photosensitive member 20Y is rotated.

A charged area of the photosensitive member 20Y reaches an exposure location with the rotation of the photosensitive member 20Y. Then, a latent image according to yellow Y image information is formed in the charged area by the exposure unit 40Y.

The latent image formed on the photosensitive member 20Y reaches a development location with the rotation of the photosensitive member 20Y and is developed by the development cartridge 50Y. In this way, a toner image is formed on the photosensitive member 20Y.

The toner image formed on the photosensitive member 20Y reaches a location of the primary transfer section B1 with the rotation of the photosensitive member 20Y and is transferred on the intermediate transfer belt 70 by a primary transfer unit. At this time, primary transfer voltage having a polarity opposite to a charging polarity of toner is applied to the primary transfer unit. In consequence, toner images of four colors respectively formed on the photosensitive members 20 (Y, M, C, and K) are transferred in an overlapped manner on the intermediate transfer belt 70 to form the full-color toner image on the intermediate transfer belt 70.

The intermediate transfer belt 70 is driven in such a manner that a driving force from a belt driving unit such as a motor is delivered through the driving roller 71a.

The full-color toner image formed on the intermediate transfer belt 70 is transferred onto the transfer medium such as a sheet by the secondary transfer unit 80. The transfer medium is transported from a feeding tray to the secondary transfer unit 80 through a feeding roller 94a and a resist roller 94b.

A full-color liquid developer image to be transferred onto the transfer medium is heated and pressurized by the fixing unit 90 to be melted and fixed on the transfer medium. The transfer medium passes through the fixing unit 90 and then is discharged by a discharging roller 94c.

On the other hand, the photosensitive members 20 (Y, M, C, and K) pass through the primary transfer sections B1, B2, B3, and B4, and then the electric charge is charge-removed by an electric charge removing unit (not shown). Thereafter, the toner attached on the surface are scraped and removed by the photosensitive member cleaning blades 76 (Y, M, C, and K) supported in the photosensitive member cleaning units 75 (Y, M, C, and K). Then, the photosensitive members 20 (Y, M, C, and K) are ready to form a subsequent latent image. The scraped and removed toner is collected by a remaining toner collecting member included in the photosensitive member cleaning units 75 (Y, M, C, and K).

An intermediate transfer belt cleaning unit (not shown) is disposed on a side of the driven roller 71b of the intermediate transfer belt 70 subjected to secondary transfer to clean the intermediate transfer belt 70 subjected to secondary transfer. An intermediate transfer method using the intermediate transfer belt has been described according to the embodiment, but a direct transfer type image forming apparatus may be used.

Next, the development cartridge 50Y will be described.

In the development cartridge 50Y, toner in different deterioration states (charging property and the like) coexists in the development chamber 51Y, when development drive is performed for a long time.

Examples of toner deterioration include deterioration in toner fluidity caused when an external additive agent such as hydrophobic silica added to toner is buried or isolated due to mechanical stress applied to toner, increase in small-diameter toner caused due to toner crush, accumulation of small-diameter toner in a development unit when development is performed selectively depending on the particle diameter of toner due to a proportion of a charging amount of toner at the time of development with respect to the particle diameter of toner, deterioration in fluidity caused due to the small-diameter toner, and occurrence of condensed clump due to deterioration in the fluidity. These examples of the toner deterioration result in image deterioration.

Since the charging amount of the small-diameter toner is excessively increased with ease and an image force is strongly applied to a latent image carrier, attachment (so-called image blushing) of toner to a non-image portion is observed in an image. In addition, since the small-diameter toner easily flies, the small-diameter toner flies from an opening of the development unit, thereby contaminating the inside of an image forming apparatus.

When toner fluidity deteriorates, frictional charge of toner in the development unit becomes insufficient. Therefore, toner having a polarity opposite to a desired charge polarity occurs. The toner having the opposite polarity is observed as the image blushing.

Since the toner deteriorating in its fluidity or the condensed clump of the toner cannot smoothly pass through a contact portion between the development roller 52Y and the regulation blade 54Y and the charge is not sufficient, the image blushing may occur. Moreover, the condensed clump of the toner is melted and fixed (so-called filming) on the surface of the development roller 52Y or the regulation blade 54Y due to a mechanical force or frictional heat in the contact portion between the development roller 52Y and the regulation blade 54Y. When the condensed clump is excessively large, the condensed clump is clogged in the contact portion. Since a toner layer is not formed on the development roller 52Y in the contact portion in which the filming or the like occurs, an image corresponding to the position is observed as a white line (image blank).

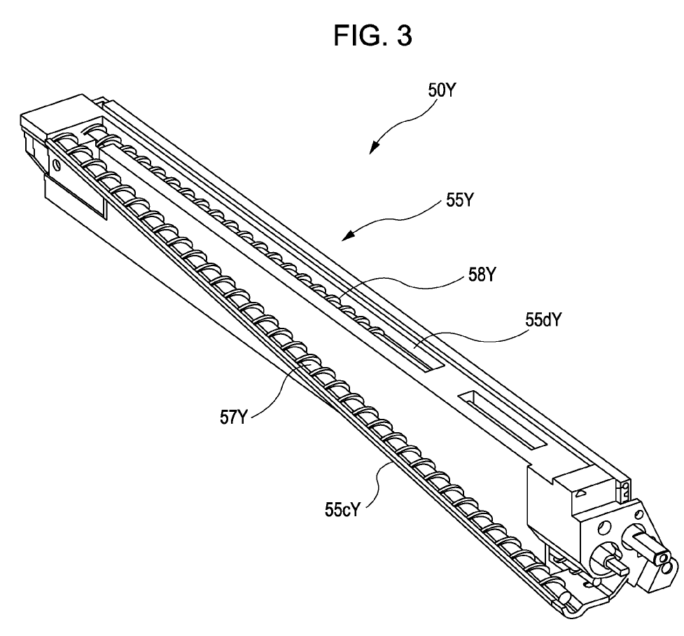

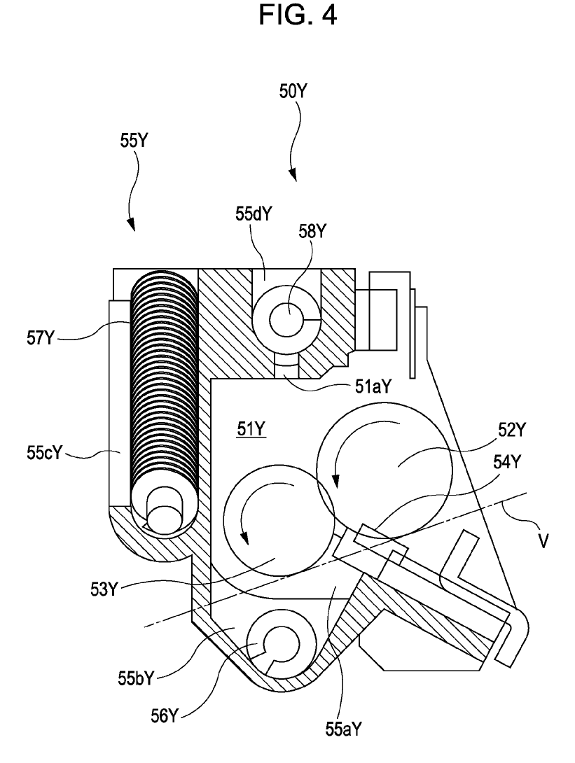

FIG. 3 is a perspective view illustrating the development cartridge 50Y according to a first embodiment of the invention. FIG. 4 is sectional view illustrating the development cartridge 50Y of FIG. 3 viewed in a direction perpendicular to an axial direction.

As shown in FIGS. 3 and 4, the development cartridge 50Y according to the first embodiment includes the development chamber 51Y and the transport section 55Y. The development chamber 51Y and the transport section 55Y are divided by a lower tangent line between the development roller 52Y and the toner supply roller 53Y, which is referred to as a boundary line V. A space formed from a development chamber entrance 51aY to the boundary line V is the development chamber 51Y. In addition, a space 55aY formed below the boundary line V, a lower transport passage 55bY, an upward transport passage 55cY, and an upper transport passage 55dY are included in the transport section 55Y.

The development chamber 51Y includes the development roller 52Y and the toner supply roller 53Y. The toner supply toner 53Y supplies toner to the development roller 52Y and can be rotated in any direction. The development roller 52Y is rotated counterclockwise. The toner is supplied from the toner supply roller 53Y to the development roller 52Y.

The transport section 55Y includes the space 55aY formed below the boundary line V, the lower transport passage 55bY, the upward transport passage 55cY, and the upper transport passage 55dY. The lower transport passage 55bY, the upward transport passage 55cY, and the upper transport passage 55dY includes a lower transport member 56Y as a lower transport unit, an upward transport member 57Y as an upward transport unit, and an upper transport member 58Y as an upper transport unit, respectively. In FIG. 3, parts of the respective transport members are exposed for description.

The space 55aY formed below the boundary line V is a space where the toner mainly passing through the nip portion of the development roller 52Y and the toner supply roller 53Y drops to the lower transport passage 55bY.

The lower transport member 56Y disposed below the development cartridge 50Y, particularly, below the toner supply roller 53Y collects the toner dropping from the space 55aY formed below the boundary line V and transports the toner in a first direction of an axial direction while agitating the toner. The lower transport member 56Y includes a screw conveyor.

The upward transport member 57Y transports the toner transported from the outside of the development chamber 51Y by the lower transport member 56Y in an upward direction of the development cartridge 50Y and a direction reverse to the first direction, while agitating the toner. The upward transport member 57Y includes a screw conveyor.

The upper transport member 58Y transports the toner transported to the upper portion by the upward transport member 57Y to the development chamber entrance 51aY of a substantial center portion in the axial direction. The upper transport member 58Y transports the toner in the first direction of the axial direction while agitating the toner, and includes a screw conveyor.

The transport members 56Y, 57Y, and 58Y are driven by a driving unit (not shown). One driving unit may drive the transport members 56Y, 57Y, and 58Y. Alternatively, a plurality of driving units provided in correspondence with the transport members 56Y, 57Y, and 58Y may drive the transport members 56Y, 57Y, and 58Y, respectively. In this embodiment, in the development cartridge 50Y including the development chamber 51Y and the transport section 55Y, a capacity of the transport section 55Y is configured to be larger than a capacity of the development chamber 51Y.

The regulation blade 54Y disposed above or below the development roller 52Y regulates an amount of toner to be supported on the development roller 52Y. When the regulation blade 54Y is provided below the development roller 52Y so as to come in contact with the development roller 52Y in a counter direction with respect to a rotation direction of the development roller 52Y, it is easier for the toner passing through the nip portion of the development roller 52Y and the toner supply roller 53Y to drop to the lower transport passage 55bY.

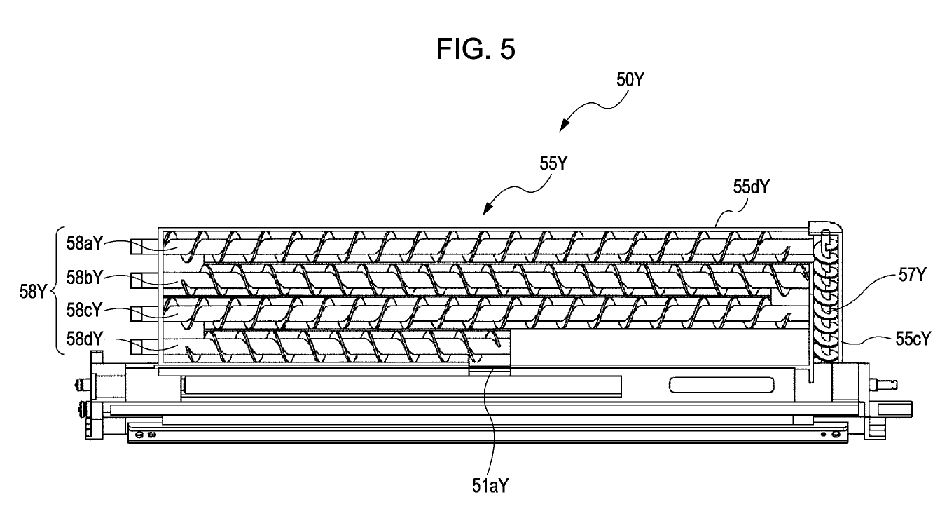

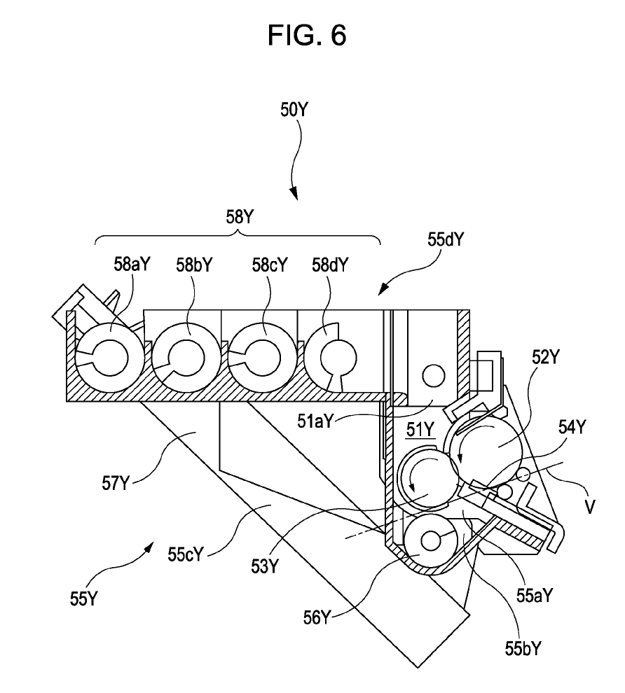

FIG. 5 is a top view illustrating the development cartridge 50Y according to a second embodiment of the invention. FIG. 6 is a sectional view illustrating the development cartridge 50Y of FIG. 5 viewed in a direction perpendicular to the axial direction.

Like the first embodiment, as shown in FIGS. 5 and 6, the development cartridge 50Y according to the second embodiment includes the development chamber 51Y and the transport section 55Y. The development chamber 51Y and the transport section 55Y are divided by a lower tangent line between the development roller 52Y and the toner supply roller 53Y, which is referred to as a boundary line V. A space formed from a development chamber entrance 51aY to the boundary line V is the development chamber 51Y. In addition, a space 55aY formed below the boundary line V, a lower transport passage 55bY, an upward transport passage 55cY, and an upper transport passage 55dY are included in the transport section 55Y.

The development chamber 51Y includes the development roller 52Y and the toner supply roller 53Y. The toner supply toner 53Y supplies the toner to the development roller 52Y and can be rotated in any direction. The development roller 52Y is rotated counterclockwise. The toner is supplied from the toner supply roller 53Y to the development roller 52Y.

The transport section 55Y includes the space 55aY formed below the boundary line V, the lower transport passage 55bY, the upward transport passage 55cY, and the upper transport passage 55dY. The lower transport passage 55bY, the upward transport passage 55cY, and the upper transport passage 55dY includes a lower transport member 56Y as a lower transport unit, an upward transport member 57Y as an upward transport unit, and an upper transport member 58Y as an upper transport unit, respectively. In FIG. 5, parts of the respective transport members are exposed for description.

The space 55aY formed below the boundary line V is a space where the toner mainly passing through a nip portion of the development roller 52Y and the toner supply roller 53Y drops to the lower transport passage 55bY.

The lower transport member 56Y disposed below the development cartridge 50Y, particularly, below the toner supply roller 53Y collects the toner dropping from the development chamber 50Y and transports the toner in the first direction of the axial direction while agitating the toner. The lower transport member 56Y includes a screw conveyor.

The upward transport member 57Y transports the toner transported from the outside of the development chamber 51Y by the lower transport member 56Y in an upward direction of the development cartridge 50Y and a direction perpendicular to the first direction, while agitating the toner. The upward transport member 57Y includes a screw conveyor.

The upper transport member 58Y is formed such that a plurality of members are arranged in parallel in a direction perpendicular to the first direction in the upper portion of the development cartridge 50Y. The upper transport member 58Y includes a first upper transport member 58aY, a second upper transport member 58bY, a third upper transport member 58cY, and a fourth upper transport member 58dY which alternately transport the toner in the first direction and in a direction reverse to the first direction. The first upper transport member 58aY transports the toner transported to the upper portion by the upward transport member 57Y in the direction reverse to the first direction while agitating the toner, and includes a screw conveyor. The second upper transport member 58bY transports the toner transported by the first upper transport member 58aY in the first direction while agitating the toner, and includes a screw conveyor. The third upper transport member 58cY transports the toner transported by the second upper transport member 58bY in the direction reverse to the first direction while agitating the toner, and includes a screw conveyor. The fourth upper transport member 58dY transports the toner to the development chamber entrance 51aY of the substantial center portion in the axial direction, and agitates the toner in the first direction of the axial direction while agitating the toner, and includes a screw conveyor.

The transport members 56Y, 57Y, and 58Y are driven by a driving unit (not shown). One driving unit may drive the transport members 56Y, 57Y, and 58Y. Alternatively, a plurality of driving units provided in correspondence with the transport members 56Y, 57Y, and 58Y may drive the transport members 56Y, 57Y, and 58Y, respectively.

The regulation blade 54Y disposed above or below the development roller 52Y regulates an amount of toner to be supported on the development roller 52Y. When the regulation blade 54Y is provided below the development roller 52Y so as to come in contact with the development roller 52Y in a counter direction with respect to a rotation direction of the development roller 52Y, it is easier for the toner passing through the nip portion of the development roller 52Y and the toner supply roller 53Y to drop to the lower transport passage 55bY.

Like the first embodiment, in the second embodiment, in the development cartridge 50Y including the development chamber 51Y and the transport section 55Y, a capacity of the transport section 55Y is configured to be larger than a capacity of the development chamber 51Y. Therefore, it is possible to increase a toner transport capability of the lower transport member 56Y, the upward transport member 57Y, and the upper transport member 58Y of the transport section 55Y. Moreover, it is possible to increase an agitating capability.

The development cartridge according to the first and second embodiments may be configured as a development unit having configuration in which toner is supplied from a toner cartridge (not shown).

Next, control of a toner transport speed will be described according to the first and second embodiment.

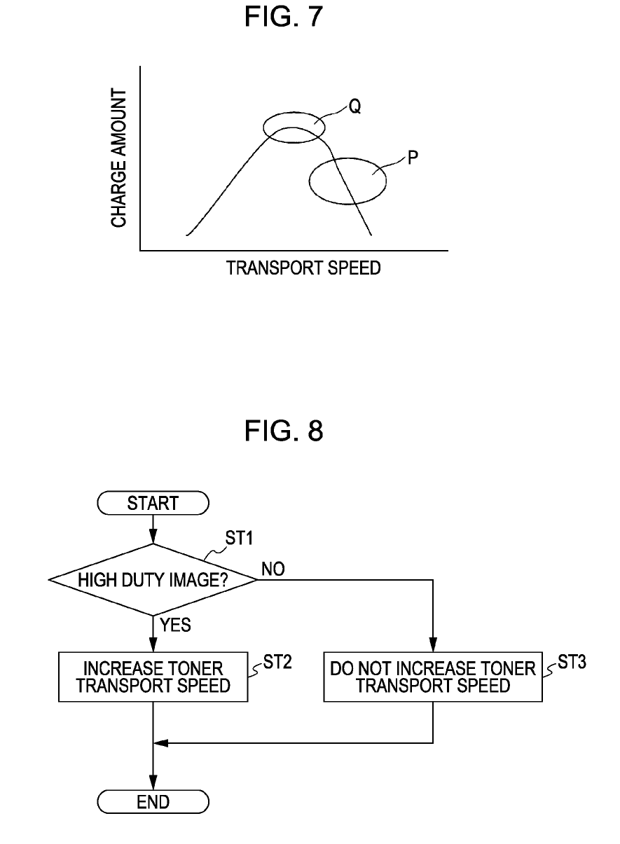

FIG. 7 is a graph illustrating a relation between a charge amount of toner and the toner transport speed at which the toner is transported through the lower transport passage 55bY, the upward transport passage 55cY, and the upper transport passage 55dY. The charge amount of toner varies depending on the toner transport speed. In this embodiment, the toner transport speed is controlled in accordance with print image data.

FIG. 8 is a flowchart illustrating control of the toner transport speed. First, in Step 1, it is determined whether an image to be printed is an image having a high duty (ST1). Here, the duty of an image refers to a ratio of a toner attachment area with respect to the entire area of the image. When the toner attachment area with respect to the entire area of the image is larger than a predetermined value, the image is referred to as a high duty image. When the toner attachment area with respect to the entire area of the image is smaller than the predetermined value, the image is referred to as a low duty image. In addition, whether the image is the high duty image may be determined by the control unit in accordance with image data transmitted from an input unit of a host computer or the like or determined by the control unit by selection of an input unit such as a touch panel by a user.

When it is determined that the image to be printed is the high duty image in Step 1, the toner transport speed is increased by increasing the rotation number of times rotated by each toner transport member in Step 2 (ST2). Alternatively, when it is determined that the image to be printed is the low duty image in Step 1, the toner transport speed is maintained without increasing the rotation number of times rotated by each toner transport member in Step 3 (ST3).

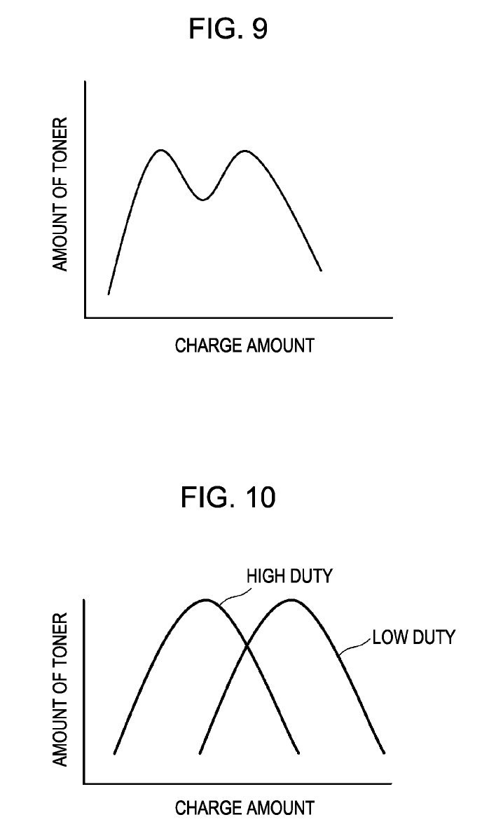

FIG. 9 is a graph illustrating an amount of toner with respect to the charge amount of toner in a lower transport passage 55bY. FIG. 10 is a graph illustrating the amount of toner with respect to the charge amount of toner in a portion through which toner enters the development chamber 51Y from the upper transport passage 55dY.

As shown in FIG. 9, peaks of two amounts of toner with respect to the charge amount of toner are shown it the lower transport passage 55bY. Therefore, it is apparent that charging is unstable. When the toner passes through the transport section 55Y to be agitated by the transport members 56Y, 57Y, and 58Y, as shown in FIG. 10, one peak of the charge amount of toner is formed. Therefore, it can be known that the charge amount of toner becomes uniform.

As shown in FIGS. 8 and 10, when the image to be printed is the high duty image of a beta image such as a photo image or a graphic image, the toner transport speed is controlled to the area P having a low charge amount by increasing the toner transport speed. Alternatively, when the image to be printed is the low duty image such as a high quality print or a character print, the toner transport speed is controlled to the area Q having a high charge amount without increasing the toner transport speed. In this way, when the image to be printed is the high duty image, it is possible to develop the image having no edge effect in which the periphery of the image becomes thick. Alternatively, when the image to be printed is the low duty image, it is possible to develop the image having sharpness.

An image desired by the user can be output by setting a plurality of modes in the image forming apparatus, independently setting an appropriate range of the charge amount of toner corresponding to the print image data in each of the modes, and adjusting the toner transport speed on the basis of each of the appropriate ranges.

For example, a first mode, a second mode, and a third mode are set in the image forming apparatus. When the first mode is set, the toner transport speed is not controlled in accordance with the print image data. When the second mode is set in the case of the high duty image, the toner transport speed is controlled to the area P having the low charge amount by increasing the toner transport speed. Alternatively, when the second mode is set in the case of the low duty image, the toner transport speed is controlled to the area Q having the high charge amount without increasing the toner transport speed. When the third mode is set in the case of the high duty image, the toner transport speed is controlled to the area Q having the high charge amount without increasing the toner transport speed. Alternatively, when the third mode is set in the case of the low duty image, the toner transport speed is controlled to the area P having the low charge amount by increasing the toner transport speed. In the case of the third mode, since the high duty image can be expressed with high density, a dynamic range of an image is broad. Therefore, the photo image or the graphic image can be formed with high precision.

As described above, the development cartridge according to this embodiment includes: the developer carrier 52Y carrying the toner; the toner supply member 53Y supplying the toner to the developer carrier 52Y; the regulation member 54Y regulating the amount of toner on the developer carrier 52Y; the development chamber 51Y including the developer carrier 52Y and the toner supply member 53Y; the transport section 55Y connected to the upper portion and the lower portion of the development chamber 51Y to transport the toner from the lower portion to the upper portion of the development chamber 51Y; the transport members 56Y, 57Y, and 58Y disposed inside the transport section 55Y and transporting the toner while agitating the toner; the input member inputting the print image; and the control member controlling the toner transport speed of the transport members 56Y, 57Y, and 58Y in accordance with the print image. When the print image is changed, the charge amount of toner in the development chamber 51Y can be changed by match with the print image.

When the print image input by the input member is the high duty image in which the ratio of the toner attachment area occupying in the entire image is larger than the predetermined value, the control member increases the toner transport speed of the transport members. Accordingly, in the case of the high duty image, it is possible to reduce the edge effect in which the periphery of the image becomes thick.

The control member sets the plurality of modes, independently sets the appropriate range of the charge amount of toner corresponding to the print image in each of the modes, and adjusts the toner transport speed on the basis of each of the appropriate ranges. Accordingly, a user selection range is broader.

As for the transport members 56Y, 57Y, and 58Y, the lower transport member 56Y is disposed below the development chamber 51Y and collects the toner, the upward transport member 57Y transports the toner from the lower portion to the upper portion of the development chamber 51Y, and the upper transport member 58Y is disposed above the development chamber 51Y and transports the toner to the development chamber entrance 51a of the development chamber 51Y. Accordingly, since time in which the toner is agitated in the transport section 55Y becomes longer, the charge amount of toner in the development chamber 51Y can be made almost sufficient and uniform.

The upper transport member 58Y includes the plurality of transport members 58aY to 58dY arranged in parallel and transporting the toner alternately in directions reverse to each other. Accordingly, since time in which the toner is agitated in the transport section 55Y becomes longer, the charge amount of toner in the development chamber 51Y can be made almost sufficient and uniform.

Since the regulation member 54Y is disposed below the developer carrier 52Y, it is easier for the toner passing through the nip portion of the development roller 52Y and the toner supply roller 53Y to drop to the lower transport passage 55bY.

The development unit according to the embodiments includes the development cartridge 50Y and the toner cartridge supplying the toner. Therefore, when new toner is supplied from the toner cartridge, the toner is agitated in many portions in the transport section 55Y. Accordingly, the charge amount of toner in the development chamber 51Y can be made almost uniform.

The image forming apparatus according to the embodiments at least includes the photosensitive member 20Y on which the electrostatic latent image is formed, the development unit which develops the electrostatic latent image by the developer to form the toner image on the photosensitive member 20Y, the transfer unit 80 which transfers the toner image formed on the photosensitive member 20Y onto the transfer medium, and the fixing unit 90 which fixes the toner image transferred on the transfer medium. As the development unit, the development unit described above is mounted on the image forming apparatus. Accordingly, a high quality image can be formed with the almost uniform charge amount.

The entire disclosure of Japanese Patent Application No. 2008-089100, filed Mar. 31, 2008 is expressly incorporated by reference herein.

What is claimed is:

1. A development cartridge comprising:
a developer carrier which carries toner;
a toner supply member which supplies the toner to the developer carrier;
a regulation member which regulates an amount of toner on the developer carrier;
a development chamber which has the developer carrier and the toner supply member;
a transport section which is connected to an upper portion and a lower portion of the development chamber to transport the toner from the lower portion of the development chamber to the upper portion of the development chamber;
a transport member which is disposed inside the transport section and transports the toner while agitating the toner;
an input member which inputs a print image; and
a control member which controls a toner transport speed of the transport member in accordance with the print image.

2. The development cartridge according to claim 1, wherein the control member increases the toner transport speed of the transport member, when the print image input by the input member is a high duty image in which a ratio of a toner attachment area occupying the entire image is larger than a predetermined value.

3. The development cartridge according to claim 1, wherein the control member sets a plurality of modes, independently sets an appropriate range of a charge amount of toner corresponding to the print image in each of the modes, and adjusts the toner transport speed on the basis of each appropriate range.

4. The development cartridge according to claim 1, wherein the transport member includes:
a lower transport member which is disposed in the lower portion of the development chamber and collects the toner;
an upward transport member which transports the toner from a lower side of the development chamber to an upper side of the development chamber; and
an upper transport member which is disposed in the upper portion of the development chamber and transports toner to a development chamber entrance.

5. The development cartridge according to claim 4, wherein the upper transport member includes a plurality of transport members which are arranged in parallel and transport the toner alternately in directions reverse to each other.

6. The development cartridge according to claim 1, wherein the regulation member is disposed below the developer carrier.

7. A development unit comprising:
the development cartridge according to claim 1; and
a toner cartridge which supplies toner.

8. An image forming apparatus comprising:
a latent image carrier on which an electrostatic latent image is formed;
a development unit which develops the electrostatic latent image by developer to form a toner image on the latent image carrier;
a transfer unit which transfers the toner image formed on the latent image carrier onto a transfer medium; and
a fixing unit which fixes the toner image transferred on the transfer unit,
wherein as the development unit, the development unit according to claim 7 is mounted.
